(19) United States
(12) Patent Application Publication
(10) Pub. No.: US 2025/0091445 A1
(43) Pub. Date: Mar. 20, 2025

(54) ELECTRIC VEHICLE WITH REGENERATIVE BRAKING

(71) Applicant: Textron Inc., Providence, RI (US)

(72) Inventors: Gregory August THEODOSAKIS, Martinez, GA (US); Russell William KING, Evans, GA (US); Jonathan Daniel BOWEN, North Augusta, SC (US)

(21) Appl. No.: 18/370,458

(22) Filed: Sep. 20, 2023

(51) Int. Cl. B60L 7/18; B60L 15/20; B60L 50/60; H01M 10/052; H01M 10/44

(52) U.S. Cl. CPC B60L 7/18; B60L 15/2018; B60L 15/2081; B60L 50/60; H01M 10/052; H01M 10/44; B60L 2200/22; B60L 2240/12; B60L 2240/16; B60L 2240/32; B60L 2240/465; B60L 2240/642; B60L 2250/28; H01M 2220/20

(57) ABSTRACT

A technique controls regenerative braking to reduce skidding of an electric vehicle. Such a technique may involve imparting rotation to an electric motor to move the vehicle to a first speed; and adjusting the limit regenerative braking power available based on a grade/slope on which the vehicle is operating. Processing circuitry may be configured to both: (a) allow a vehicle to have unrestricted or less restricted regenerative braking for more quickly slowing the vehicle when desired such as on flat dry pavement and/or on flat ground, and (b) limit, or more significantly limit, the vehicle's deceleration in situations such as when traveling downhill on a steep grade to reduce chances of sliding/skidding.

A technique controls regenerative braking to reduce skidding/sliding of an electric vehicle. Such a technique may involve imparting rotation to an electric motor to move the vehicle to a first speed; and adjusting the limit regenerative braking power available based on a grade/slope on which the vehicle is operating. Processing circuitry may be configured to both: (a) allow a vehicle to have unrestricted or less restricted regenerative braking for more quickly slowing the vehicle when desired such as on flat dry pavement and/or on flat ground, and (b) limit, or more significantly limit, the vehicle's deceleration in situations such as when traveling downhill on a steep grade to reduce chances of sliding/skidding.

### BACKGROUND

A conventional electric vehicle includes a rechargeable battery and an electric motor connected to the vehicle's drive wheels through the drivetrain. To drive the electric motor and thus move the vehicle, a vehicle operator depresses an accelerator pedal. Similarly, to slow the electric motor and provide braking to the vehicle, the vehicle operator depresses a brake pedal.

Some conventional electric vehicles perform regenerative braking when slowing the vehicle. In regenerative braking, the drive wheels turn the electric motor to convert kinetic energy of the moving vehicle into electrical energy which is stored back into the rechargeable battery for future use.

### BRIEF SUMMARY OF CERTAIN EXAMPLE EMBODIMENTS

There may be deficiencies associated with a conventional electric vehicle which simply and blindly performs regenerative braking when slowing the vehicle. For example, for a particular conventional electric vehicle, suppose that the electric motor is an alternating current (AC) motor which provides regenerative braking at a maximum power level when the vehicle operator partially or fully releases the accelerator pedal. In such a situation, the AC motor may provide regenerative braking torque to the drive wheels of the electric vehicle which exceeds the coefficient of friction between the drive wheels and the drive surface. As a result, the drive wheels will slip or skid on the drive surface causing an unsafe event.

The force of gravity acts to pull a vehicle downhill. Regenerative braking, in turn, produces motor torque which counters this downward pull by slowing the drive wheels. Skidding occurs when the force of gravity overcomes the frictional force at the drive wheels as they are resisting gravity to slow the vehicle. This is particularly applicable when the surface of the steep grade is already a low friction surface, such as a wet surface, grass, wet grass, etc.

A technique of limiting motor current during regenerative braking is used on TSV electric vehicles today to reduce the likelihood of skidding when descending hills. For example, see U.S. Pat. No. 11,673,474, the disclosure of which is hereby incorporated herein by reference in its entirety. Current limiting reduces the magnitude of motor torque during regenerative braking which reduces the torque at the drive wheels and therefore reduces the likelihood of skidding. However, this current limiting during regenerative braking is blind to vehicle conditions and for example is applied independent of the slope on which the vehicle is operating and irrespective of the surface on which the vehicle is traveling. This, for example, applies limits to regenerative braking on both steep slopes, as well as on shallow slopes or flat ground where skidding is not particularly hazardous or as likely compared to steeper slopes. Legacy controllers do not contain any sensory devices that allow direct measurement of grade for example. This necessitates the current limiting to be applied universally across all slopes. Without the ability to determine undesirable vehicle orientation in terms of likelihood to skid while regeneratively braking, current limiting of regenerative braking must be applied independent of vehicle orientation. This can limit the vehicle's deceleration even in situations when not needed to prevent/reduce skidding, and so that regenerative braking is limited on shallow grades and/or flat ground when it would be more desirable to have unrestricted regenerative braking for more quickly slowing the vehicle when desired by the vehicle operator.

Improved techniques are directed to controlling regenerative braking provided by a motor (e.g., induction motor) of a vehicle to reduce skidding and/or slipping of the vehicle wheel(s) and/or the vehicle itself, wherein control of the regenerative braking is based on at least one of: (i) a slope/grade on which the vehicle is located and/or traveling, (ii) a type of surface (e.g., grass vs. pavement) on which the vehicle is located and/or is traveling, and/or (iii) a degree of wetness of the surface on which the vehicle is located and/or is traveling. For example, adjusting current limiting based on the grade/slope on which the vehicle is located/traveling, can prevent or reduce skidding on steep hills while allowing full deceleration performance in other conditions such as on flat ground or shallow grades.

Certain example embodiments use angular position of the vehicle (e.g., based on the grade/slope on which the vehicle is located) and/or direction data of the vehicle to determine vehicle orientation where loss of traction is likely and/or hazardous. Vehicle operation on steep downward slopes is indicative of these conditions for example. When hazardous conditions are detected (e.g., based on one or more of the items (i)-(iii) identified above), certain example embodiments limit the regenerative braking torque available at lower, near-skidding RPMs. By limiting regenerative braking torque on steep downward slopes for example, the likelihood of losing tire traction is reduced which reduces the likelihood of skidding and/or loss of vehicle control while traveling downhill.

Certain example embodiments may use an IMU (inertial measurement unit) to determine the grade on which the vehicle is operating for example. Other techniques for estimating, detecting, and/or measuring grade may instead or also be used. By using the angular data from the IMU or other grade estimation/determination, a controller comprising processing circuitry (e.g., a motor controller) may be configured to reduce regenerative current limits to prevent or reduce a likelihood of skidding when necessary (e.g., while descending a steep hill), and allow full and/or a higher amount of regenerative current in less skid-likely scenarios such as on shallow grades and/or flat ground. For example and without limitation, a controller (e.g., of or including a processor, and/or circuitry) may be configured to limit regenerative braking on steep grades (e.g., grades of at least 5 degrees relative to the horizontal), and provide less or no limiting of regenerative braking to allow for a higher amount of or full regenerative current on low grades (e.g., grades less than 5 degrees relative to the horizontal), flat ground, and/or uphill. Thus, for example and without limitation, a controller (e.g., of or including a processor, and/or circuitry) may be configured to limit regenerative braking on steep grades (e.g., grades of at least 5 degrees relative to the horizontal) so that the vehicle does not slow down as quickly, and for instance allow full or a higher amount of regenerative current so that the vehicle can slow down more quickly on low grades (e.g., grades less than 5 degrees relative to the horizontal), flat ground, and/or uphill, for purposes of safety discussed herein.

Such techniques may reduce the power available from regenerative braking on steep hills for example. Such reduction of regenerative braking power lowers the amount of braking torque imposed by the induction motor on the drive wheels of the vehicle. Accordingly, vehicle wheels are less prone to slipping and/or skidding on the steep and/or slippery drive surfaces for example, thus improving safety of the vehicle.

Thus, processing circuitry in certain example embodiments can be configured to both: (a) allow a vehicle to have unrestricted or less restricted regenerative braking for more quickly slowing the vehicle when desired such as on flat dry pavement and/or on flat ground, and (b) limit, or more significantly limit, the vehicle's deceleration in situations such as when traveling downhill on a steep grade to reduce chances of sliding or skidding.

An example embodiment is directed to an electric vehicle which includes a vehicle body, a rechargeable battery supported by the vehicle body, an induction motor supported by the utility vehicle body, and control circuitry coupled with, directly or indirectly, the rechargeable battery and the induction motor. The control circuitry is configured to control regenerative braking to reduce skidding of the vehicle at least by one or more of:
(A) imparting rotation to the induction motor to move the vehicle,
(B) while the vehicle is on and/or traveling down a slope with a grade/slope higher than a predetermined value, applying a first power level limit for regenerative braking to the induction motor, and
(C) while the vehicle is on at least one of a flat surface, traveling uphill, and/or traveling down a slope with a grade/slope lower than a predetermined value (shallow non-steep slope), not applying a limit for regenerative braking or applying a second power level limit for regenerative braking to the induction motor, the second power level limit allowing for more regenerative braking and higher vehicle deceleration compared to the first power level limit. Each of the first power level limit and the second power level limit may impose an upper limit to power available to the induction motor during regenerative braking.

In some arrangements, imparting rotation to the induction motor to move the vehicle may include at least one of: (a) sensing that a forward/reverse switch of the vehicle is set to a forward position, (b) sensing operation of an accelerator pedal of the vehicle, and (c) in response to sensing that the forward/reverse switch is set to the forward position and sensing operation of the accelerator pedal, driving the induction motor to move the vehicle in a forward direction.

In certain example embodiments, the vehicle may be a golf car (or any other suitable vehicle) having a lithium-inclusive battery; and/or the induction motor may be an alternating current (AC) motor for driving at least one wheel of the golf car using power from the battery. The regenerative braking is for slowing the vehicle while preventing or reducing a chance of the wheels skidding while the golf car moves over a surface. Also, the regenerative braking is for recharging the battery.

In an example embodiment, there may be provided an electric vehicle comprising: a vehicle body; at least one sensor configured to detect angular positional data (e.g., one or more of angular speed, acceleration, position data based on a map, travel direction) of the vehicle; a rechargeable battery supported by the vehicle body; a motor (e.g., induction motor); and control circuitry coupled with the rechargeable battery, the at least one sensor, and the motor; wherein the control circuitry is configured to control regenerative braking of the vehicle to reduce a chance of vehicle skidding at least by adjusting a limit of regenerative braking power available to the vehicle based on the angular positional data from the at least one sensor. “Based on” as used herein covers based at least on. The at least one sensor may be configured so that the angular positional data is indicative of a grade/slope on which the vehicle is operating. The regenerative braking may also be for recharging the battery.

In an example embodiment, there is provided a method of performing regenerative braking in a vehicle, the method comprising: at least one sensor of the vehicle detecting angular positional data of the vehicle; and controlling regenerative braking of the vehicle, which recharges a battery of the vehicle, at least by adjusting a limit of regenerative braking power available to the vehicle based on the angular positional data from the at least one sensor.

### BRIEF DESCRIPTION OF THE DRAWINGS

The foregoing and other objects, features and/or advantages will be apparent from the following description of particular embodiments, as illustrated in the accompanying drawings in which like reference characters refer to the same parts throughout the different views. The drawings are not necessarily to scale, emphasis instead being placed upon illustrating the principles of various example embodiments. Each embodiment herein may be used in combination with any other embodiment(s) described herein.

FIG. 1 is a perspective view of an example utility vehicle which controls regenerative braking to reduce skidding of a vehicle.

FIG. 2 is a block diagram of particular systems and components of the utility vehicle of FIG. 1 in accordance with some example embodiments.

FIG. 3 is a block diagram of additional details of the utility vehicle of FIG. 1 in accordance with some example embodiments.

FIG. 4 is a block diagram of particular details of control circuitry of the utility vehicle of FIG. 1 in accordance with some example embodiments.

FIG. 5 is a general diagram illustrating input to and output from the control circuitry of FIG. 4 in accordance with some example embodiments.

FIG. 6 is a graph of an example power limiting function imposed by the control circuitry of the utility vehicle in accordance with some example embodiments.

FIG. 7 is a flowchart of a procedure which is performed by the utility vehicle in accordance with some example embodiments.

FIGS. 8(A)-(B) are diagrams of controlling regenerative braking in an electric vehicle according to certain example embodiments.

FIGS. 9(A)-(B) are diagrams of a system for controlling regenerative braking in an electric vehicle according to certain example embodiments.

### DETAILED DESCRIPTION OF EXAMPLE EMBODIMENTS

Referring now more particularly to the accompanying drawings in which like reference numerals indicate like parts throughout the several views.

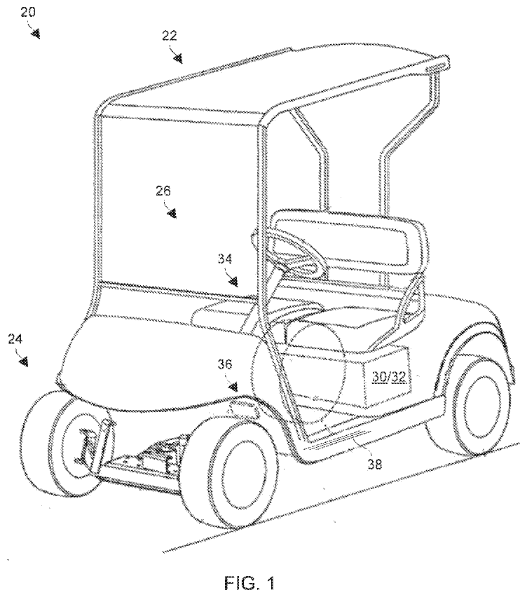

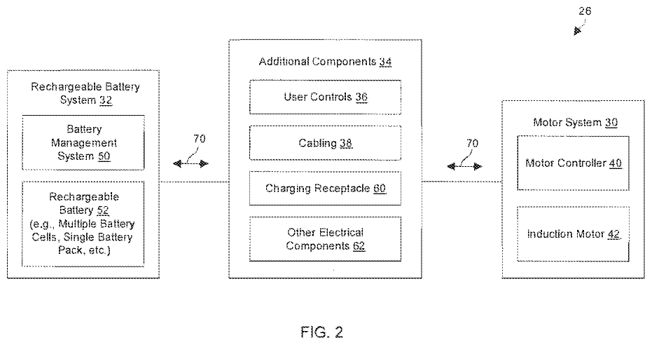

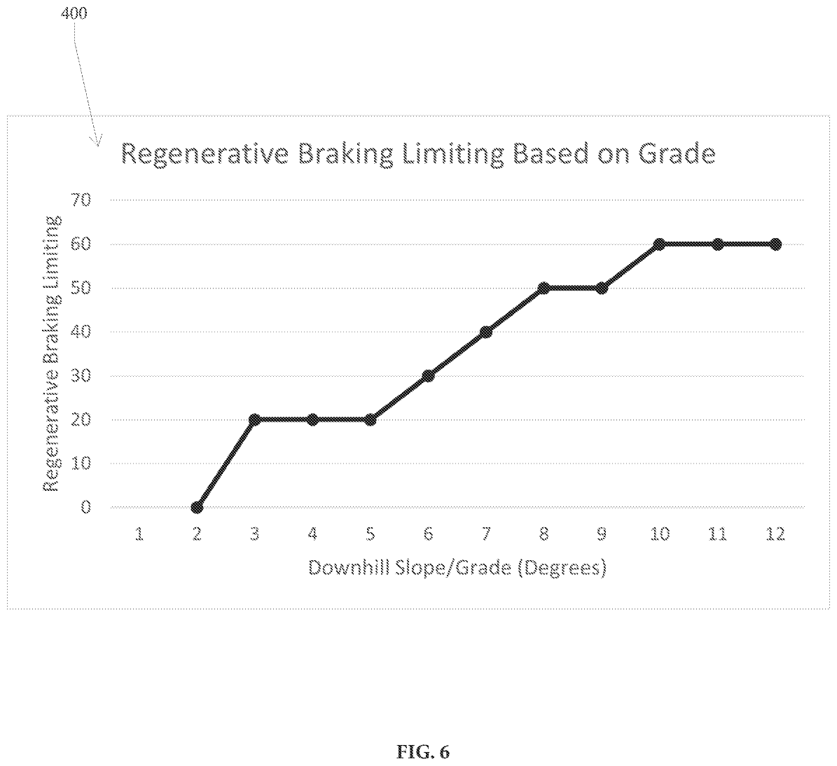

Improved techniques are directed to controlling regenerative braking provided by a motor (e.g., see induction motor 42 in FIGS. 2, 3, 5, and 8-9) of a vehicle (e.g., see the vehicle 20 in FIG. 1) to reduce skidding and/or slipping of the vehicle wheel(s) and/or the vehicle itself. Control of the regenerative braking may be based on at least one of: (i) a slope/grade on which the vehicle is located and/or traveling, such as shown in FIGS. 6-9, (ii) a type of surface (e.g., grass vs. pavement) on which the vehicle is located and/or is traveling, and/or (iii) a degree of wetness of the surface on which the vehicle is located and/or is traveling. For example, adjusting regenerative braking current limiting based on the grade/slope on which the vehicle is located/traveling (e.g., see FIGS. 6-9) can prevent or reduce chances of skidding/slipping when traveling down steep hills, while allowing full deceleration performance in other conditions such as on flat ground or shallow grades. In certain example embodiments, surface wetness may be inferred based on a detecting wheel slip and/or angle indicating a surface with a low coefficient of friction.

In certain example embodiments, control circuitry 200 (e.g., which may be part of motor controller 40 and/or battery management system 50, or may be separate from both) may use angular position of the vehicle 20 from at least one sensor 210, 320 (e.g., for sensing angle data of the vehicle indicative of the grade/slope on which the vehicle is located/operating) and/or direction data of the vehicle to determine vehicle orientation, in order to determine situations where loss of traction is more likely and/or hazardous. Vehicle operation on steep downward slopes is indicative of these conditions for example. When hazardous conditions are detected (e.g., based on one or more of the items (i)-(iii) identified above), control circuitry in certain example embodiments limits the regenerative braking torque available at lower, near-skidding RPMs. By limiting regenerative braking torque on steep downward slopes for example, the likelihood of losing tire traction is reduced which reduces the chance of skidding and/or loss of vehicle control while traveling downhill.

Regarding the sensor(s) 210, 320, certain example embodiments may use an IMU (inertial measurement unit) to determine (e.g., estimate) the grade on which the vehicle is operating for example. Other techniques for estimating, detecting, and/or measuring grade may instead or also be used, such as grade determination (e.g., estimation) based on internal controller signal(s) such as speed, torque, current, etc., and/or combining position from GPS with topographical information such as via predicting grade based on map location and/or direction of travel. By using the angular data (e.g., one or more of angular speed, acceleration, position data based on a map, travel direction, and/or the like) from the IMU or other grade determination (e.g., estimation), a controller comprising processing circuitry (e.g., a motor controller) may be configured to reduce regenerative current limits to prevent or reduce a likelihood of skidding when necessary (e.g., while descending a steep hill), and allow full and/or a higher amount of regenerative current in less skid-likely scenarios such as on shallow grades and/or flat ground. In certain example embodiments, an IMU may output angular speed and/or acceleration data, and angular position may then be calculated from this IMU angular data. For example and without limitation, a controller (e.g., of or including a processor, and/or circuitry 200) may be configured to limit regenerative braking on steep grades (e.g., grades of at least 5 degrees relative to the horizontal), and not to limit regenerative braking and for instance allow full or a higher amount of regenerative current on low grades (e.g., grades less than 5 degrees relative to the horizontal), flat ground, and/or uphill. Thus, for example and without limitation, a controller (e.g., of or including a processor, and/or circuitry 200) may be configured to limit regenerative braking on steep grades (e.g., grades of at least 5 degrees relative to the horizontal) so that the vehicle 20 does not slow down as quickly, and for instance allow full or a higher amount of regenerative current so that the vehicle 20 can slow down more quickly on low grades (e.g., grades less than 5 degrees relative to the horizontal), flat ground, and/or uphill, for purposes of safety discussed herein.

Such techniques (e.g., see FIGS. 6-9) may reduce the power available from regenerative braking on steep hills for example. Such reduction of regenerative braking power lowers the amount of braking torque imposed by the induction motor 42 on the drive wheels of the vehicle 20. Accordingly, vehicle wheels are less prone to slipping and/or skidding on the steep and/or slippery drive surfaces for example, thus improving safety of the vehicle.

Thus, processing circuitry 200 in certain example embodiments can be configured to both: (a) allow a vehicle to have unrestricted or less restricted regenerative braking for more quickly slowing the vehicle when desired such as on flat dry pavement and/or on flat ground, and (b) limit, or more significantly limit, the vehicle's deceleration in situations such as when traveling downhill on a steep grade to reduce chances of sliding or skidding.

Vehicle drive wheel skidding is most likely to occur when descending steep hills during regenerative braking. The force of gravity acts to pull the vehicle downhill. Regenerative braking, in turn, produces motor torque which counters this downward pull by slowing the drive wheels. Skidding occurs when the force of gravity overcomes the frictional force at the drive wheels as they are resisting gravity to slow the vehicle. This is particularly applicable when the surface of the steep grade is already a low friction surface, such as a wet surface, grass, wet grass, etc.

The control circuitry 200 may be configured to control regenerative braking to reduce skidding of the vehicle 20 at least by one or more of: (A) imparting rotation to the motor 42 (e.g., induction motor, or any other type of motor) to move the vehicle, (B) while the vehicle 20 is on and/or traveling down a slope with a grade/slope higher than a predetermined value, applying a first power level limit for regenerative braking to the motor 42, and (C) while the vehicle is on at least one of a flat surface, traveling uphill, and/or traveling down a slope with a grade/slope lower than a predetermined value (shallow non-steep slope), not applying a limit for regenerative braking or applying a second power level limit for regenerative braking to the motor 42, the second power level limit allowing for more regenerative braking and faster vehicle deceleration compared to the first power level limit. Each of the first power level limit and the second power level limit may impose an upper limit to power available to the motor(s) 42 during regenerative braking.

In certain example embodiments, a maximum current limit may be imposed on the motor(s) 42 to protect control circuitry that controls the motor(s). Additionally, directing the motor 42 to provide the braking torque that slows the vehicle 20 in accordance with the second power level limit may include for example reducing the maximum current limit by less than 10% to provide, as the second power level limit, a current limit which is at least 90% of the maximum current limit. Furthermore, directing the motor to provide the braking torque that slows the vehicle in accordance with the first power level limit may include reducing the maximum current limit by at least 30% (more preferably by at least 40%, and sometimes by at least 50%) to provide, as the first power level limit, a current limit which is less than 70% (more preferably less than 60%, and sometimes less than 50%) of the maximum current limit. In certain example embodiments, computerized memory of the vehicle may store power limiting data. Additionally, applying the first power level limit for regenerative braking to the motor may include accessing the power limiting data to identify a first power level limit setting, and operating the motor in accordance with the first power level limit setting to provide braking torque that slows the vehicle. In certain example embodiments, applying the second power level limit for regenerative braking to the motor may include accessing the power limiting data to identify a second power level limit setting which is different from the first power level limit setting, and operating the motor in accordance with the second power level limit setting to provide braking torque that slows the vehicle. In certain example embodiments, the power limiting data may include a power limiting map having multiple map entries, where each map entry may map a different motor rotation rate to a respective power level limit setting.

Thus, in certain example embodiments, there may be provided an improved technique for controlling regenerative braking by an motor(s) of a vehicle to reduce skidding of the vehicle 20. Such a technique may reduce the power available from regenerative braking, using the motor(s) 42 to provide braking and to recharge a battery 52, on steep downhill slopes. Such limiting of regenerative braking power can lower the amount of braking torque imposed by the motor(s) 42 on the drive wheel(s) of the vehicle on such steep downhill slopes. As a result, the drive wheel(s) are less prone to slipping or skidding thus improving vehicle safety.

The various individual features of the particular arrangements, configurations, and embodiments disclosed herein can be combined in any desired manner that makes technological sense. Additionally, such features are hereby combined in this manner to form all possible combinations, variants and permutations except to the extent that such combinations, variants and/or permutations have been expressly excluded or are impractical. Support for such combinations, variants and permutations is considered to exist in this document.

FIG. 1 shows an example utility vehicle 20 which controls regenerative braking to reduce skidding. The utility vehicle 20 may include a utility vehicle body 22 (e.g., a chassis, a frame, or the like), a set of wheels/tires 24, and a motion control system 26. It should be understood that the utility vehicle 20 has the form factor of a golf car by way of example only and that other utility vehicle form factors are suitable for use as well such as those of personal transport vehicles, food and beverage vehicles, hospitality vehicles, all-terrain vehicles (ATVs), utility task vehicles (UTVs), motorcycles, scooters, vehicles for specialized applications, as well as other lightweight vehicles and utility vehicles. In certain example embodiments, the vehicle need not have an anti-lock braking system.

The motion control system 26 controls vehicle movement such as drive provided by the set of wheels/tires 24, speed control, braking, and so on thus enabling the utility vehicle 20 to perform useful work. The motion control system 26 of the illustrated embodiments may include, among other things, a motor system 30, a rechargeable battery system 32, and additional components 34 such as a set of user controls 36 (e.g., foot pedals, a keyed switch, a maintenance switch, etc.) and cabling 38.

It should be understood that certain components of the motor control system 26 (or portions thereof) may be disposed within a set of compartments (in one or more compartments) under a set of seats (under one or more seats) of the utility vehicle 20. For example, a compartment underneath a seat of the utility vehicle 20 may house one or more rechargeable batteries, control circuitry, cabling, controls, etc. for ease of access/serviceability, for protection against damage, for security, and so on. However, these are just examples, and components may be provided at other locations of the vehicle 20.

It should be further understood that the motion control system 26 may include other apparatus/components as well. Along these lines, the motion control system 26 may further includes a drivetrain (e.g., a set of gears, linkage, etc.) that connects the motor system 30 to the set of wheels/tires 24 (e.g., two drive wheels and two non-drive wheels), a steering wheel (or column), a steering gear set that connects the steering wheel to certain wheels/tires 24, a set of brakes, other controls and sensors, and so on.

As will be explained in further detail shortly, the utility vehicle 20 includes an motor(s) which runs on electric power from a rechargeable battery and is equipped with a regenerative braking control feature which can lower regenerative braking power of the motor to reduce skidding of the vehicle.

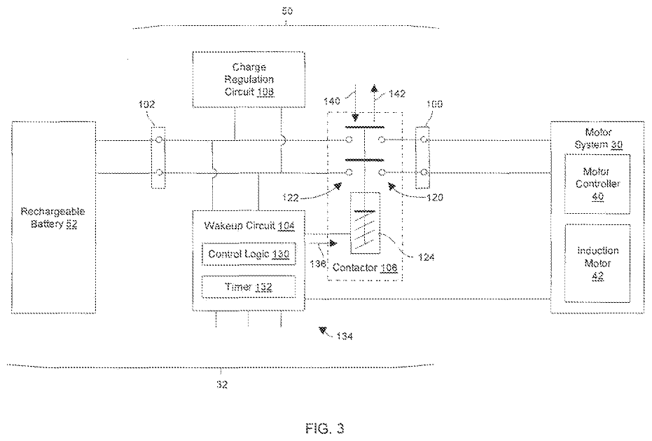

FIGS. 2 and 3 show example details of the motion control system 26 of the utility vehicle 20 (FIG. 1) in accordance with certain example embodiments. FIG. 2 shows certain general components of the motion control system 26 and how these components are related. FIG. 3 shows particular lower level details of the motion control system 26 in accordance with some embodiments.

As shown in FIG. 2, the motor system 30 may include a motor controller(s) 40 and an motor(s) 42. The motor controller 40 controls delivery of stored electric power from the rechargeable battery system 32 to the motor 42 which ultimately turns at least one of the wheels/tires 24 to move the utility vehicle 20. Additionally, the motor controller 40 controls delivery of regenerative power from the motor 42 to recharge the rechargeable battery system 32 (e.g., during braking, while the utility vehicle 20 coasts downhill without any pedal depression, and/or during accelerator pedal release, etc.).

In some embodiments, a safety limit (e.g., a current or power limit) may be set on the controller to limit the maximum amount of current that can pass through the motor controller 40 to prevent or reduce premature wear or damage to the motor controller 40 or other electrical components. The upper limit of torque available for regenerative braking is dependent on this safety limit set on the motor controller 40.

Induction motor 42 may include a stator having multiple (e.g., three) phase windings, and a rotor connected, directly or indirectly, to the drive wheel(s). The motor controller 40 may operate the motor 42 by providing a three-phase AC current through the stator to produce a rotating magnetic field which rotates the rotor either in the forward or reverse direction. The motor controller 40 controls the rate of rotation and strength by controlling the frequency and amplitude of the AC current. Other types of motor 42 may instead be used, such as any motor than can provide braking torque (e.g., PMAC, Brushless DC, Brushed Separately Excited DC, Switched Reluctance, etc.)

The rechargeable battery system 32 may include a battery management system (BMS) 50 and a rechargeable battery 52. The BMS 50 controls electrical access to the rechargeable battery 52. Additionally, the BMS 50 may respond to various events such as sleep events (e.g., timeouts) to prevent or reduce excessive discharging of the rechargeable battery 52 thus safeguarding the rechargeable battery 52 from becoming over discharged. The BMS 50 may respond to other events as well such as wakeup events (e.g., actuation of the user controls 36), charging situations, fault conditions, and so on to control charging and discharging of the rechargeable battery 52.

It should be understood that a variety of battery types and form factors are suitable for the rechargeable battery 52. For example, the rechargeable battery 52 may be a lithium inclusive battery which includes multiple lithium inclusive battery cells, a single battery pack, combinations thereof, and so on. As another example, the rechargeable battery 52 may utilize one or more lead acid batteries in place of, or in combination with, the lithium inclusive battery, and so on.

The additional components 34 may, for example, include one or more of a set of user controls 36 (e.g., pedals, switches, etc.), cabling 38, a charging receptacle 60, and perhaps other electrical components (or loads) 62 (e.g., lights, a global positioning system (GPS), specialized equipment, etc.). In some arrangements, the cabling 38 may include a communications bus, such as, for example, a controller area network (CAN) bus through which the motor system 30 and the rechargeable battery system 32 can exchange communications 70 such as electronic CAN messages in accordance with the CAN protocol.

As shown in FIG. 3, in accordance with some example embodiments, the battery management system (BMS) 50 of the rechargeable battery system 32 may include a power delivery interface 100, a battery interface 102, a wakeup circuit 104, a contactor 106, and a charge regulation circuit 108. These components may reside together as a single assembly or unit (e.g., within the same enclosure, within adjacent compartments, etc.) or in a distributed manner among different locations on the utility vehicle body 22.

The power delivery interface 100 couples with the motor system 30. Similarly, the battery interface 102 couples with the rechargeable battery 52. The wakeup circuit 104 controls closing and opening of the contactor 106 to electrically connect the motor system 30 to the rechargeable battery 52 and disconnect the motor system 30 from the rechargeable battery 52, respectively. During such operation, the charge regulation circuit 108 controls signal conditioning during discharging and charging of the rechargeable battery 52.

As further shown in FIG. 3, the contactor 106 may include a set of target contacts 120 that couple with the power delivery interface 100, a set of source contacts 122 that couple with the battery interface 102, and an electromagnetic actuator 124. “Couple” and “connect” herein cover both direct and indirect coupling/connecting. Although FIG. 3 shows the contactor 106 controlling two signal paths between the motor system 30 and the battery 52 by way of example (there are two source contacts 122 and two target contacts 120), other arrangements include different numbers of contacts and signal paths (e.g., one, three, four, etc.) may instead be provided depending on the particular application/electrical needs/etc. (e.g., DC power signals at different voltages, AC power signals in different phases, ground, etc.). The operation of the contactor 106 prevents or reduces a chance of over-discharging of the rechargeable battery 52 and is thus well suited for certain embodiments such as when the rechargeable battery 52 includes a lithium battery.

The wakeup circuit 104 may include control logic 130 and a timer 132 which operate to manage access to the rechargeable battery 52. Such operation may be based on a variety of inputs 134 from the motor system 30, from the user controls 36 (directly or indirectly), and/or the like. Along these lines, in response to a wakeup event (e.g., a user turning on the BMS 50), the wakeup circuit 104 may output an actuator signal 136 that actuates the electromagnetic actuator 124 in a first direction 140 from a first position to a second position that connects respective source contacts 122 to corresponding target contacts 120 to electrically connect the motor system 30 to the rechargeable battery 52. Along these lines, the electromagnetic actuator 124 may be provisioned with a solenoid or coil that closes the contactor 106 in response to the actuator signal 136.

Additionally, in response to a sleep event (e.g., encountering a predefined time period of non-use while the BMS 50 is awake), the wakeup circuit 104 may terminate output of the actuator signal 136 which releases the electromagnetic actuator 124. In particular, the electromagnetic actuator 124 is spring biased in a second direction 142 which is opposite the first direction 140. Accordingly, termination of the actuator signal 136 enables the electromagnetic actuator 124 to return back from the second position to the first position thus automatically separating the source contacts 122 from the target contacts 120 when the wakeup circuit 104 terminates output of the actuation signal 136 thus disconnecting the motor system 30 from the rechargeable battery 52. As a result, there are no significant parasitic loads placed on the rechargeable battery 52 that could otherwise further discharge the rechargeable battery 52 to an over-depleted state.

In other embodiments, the wakeup circuit 104 does not need to constantly maintain the actuator signal 136. Instead, the wakeup circuit 104 may control engagement and disengagement of the contactor 106 using discrete engagement and disengagement signals. With such use of a dedicated release signal, maintenance of a signal and termination for release is not required. A utility vehicle having a similar wakeup/sleep feature is described in U.S. Pat. No. 10,322,688, the disclosure of which is hereby incorporated herein by reference in its entirety.

Furthermore, in some embodiments, other conductive pathways may exist between the vehicle's power supply (e.g., the rechargeable battery 52) and the motor system 30 that do not extend through the contactor 106. Moreover, in some embodiments, such as lead acid battery powered vehicles, the motor system 30 may connect, directly or indirectly, to a set of lead acid batteries (e.g., where there is no over-discharge protection by a contactor 106). Any battery type may be used for battery 52 in various example embodiments, such as lithium ion inclusive, lead acid, nickel inclusive, metal hydride, etc.

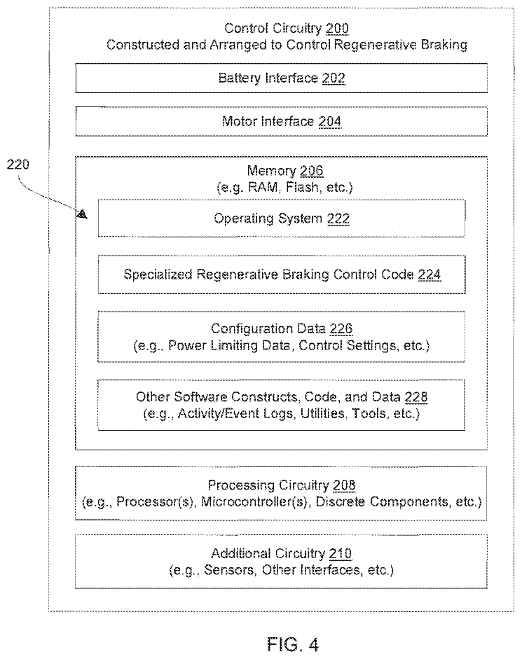

FIG. 4 shows an example of control circuitry 200 that controls regenerative braking to reduce skidding of a vehicle. The control circuitry 200 may include, in an example embodiment, one or more of: a battery interface 202, a motor interface 204, memory 206, processing circuitry 208, and additional circuitry 210.

In accordance with certain embodiments, the control circuitry 200 may form at least a portion of the motor controller 40 or may be separate from the motor controller 40 (also see FIGS. 2 and 3). Additionally or alternatively, the control circuitry 200 may form at least a portion of the battery management system 50 or may be separate from the battery management system 50 (also see FIGS. 2 and 3). The control circuitry 200, including parts thereof, may be located at any suitable location on the vehicle.

The battery interface 202 may be constructed and arranged to connect the control circuitry 200 to the rechargeable battery 52 of the rechargeable battery system 32. In accordance with some embodiments, the battery interface 202 may connect to the rechargeable battery 52 through at least the contactor 106 (e.g., when the rechargeable battery 52 includes a set of lithium batteries). In accordance with other embodiments, the battery interface 202 may connect directly to the rechargeable battery 52 (e.g., when the rechargeable battery 52 includes only a set of lead acid batteries).

The motor interface 204 may be constructed and arranged to connect the control circuitry 200 to the motor(s) 42 of the motor system 30. In accordance with some embodiments, the number of conductors within the motor interface 204 may depend on the number of poles (e.g., the number of sets of three-way electromagnetic windings) in the motor(s) 42 (e.g., a 2-pole AC motor, a 4-pole AC motor, a 6-pole AC motor, etc.).

The memory 206 may store a variety of memory constructs 220 including an operating system 222, specialized regenerative braking control code 224, configuration data 226 (e.g., power limiting data, control settings, etc.), and other software constructs, code and data 228 (e.g., activity/event logs, utilities, tools, etc.). Although the memory 206 is illustrated as a single block in FIG. 4, the memory 206 is intended to represent both volatile and non-volatile storage (e.g., random access memory, flash memory, magnetic memory, etc.), and may, in some embodiments, include a plurality of discrete physical memory units.

The processing circuitry 208 may be configured to run in accordance with instructions of the various memory constructs 220 stored in the memory 206. In particular, the processing circuitry 208 may run the operating system 222 to manage various computerized resources (e.g., processor cycles, memory allocation, etc.). Additionally, the processing circuitry 208 may run the specialized regenerative braking control code 224 to electronically control regenerative braking power. The processing circuitry 66 may be implemented in a variety of ways including via one or more processors and/or cores running specialized software, application specific ICs (ASICs), field programmable gate arrays (FPGAs) and associated programs, microcontrollers, discrete components, analog circuits, other hardware circuitry, combinations thereof, and so on. In the context of one or more processors executing software, a computer program product may be capable of delivering all or portions of the software to the control circuitry 200 (e.g., also see the memory constructs 220 in FIG. 4). The computer program product may have a non-transitory (or non-volatile) computer readable medium which stores a set of instructions which controls one or more operations of the control circuitry 200. Examples of suitable computer readable storage media include tangible articles of manufacture and other apparatus which store instructions in a non-volatile manner such as flash memory, a magnetic storage medium (e.g., various disk memories such as a hard drive, floppy disk, or other magnetic storage medium), tape memory, optical disk (e.g., CD-ROM, DVD, Blu-Ray, or the like), and the like. It will be appreciated that various combinations of such computer readable storage media may be used to provide the computer readable medium of the computer program product in some embodiments.

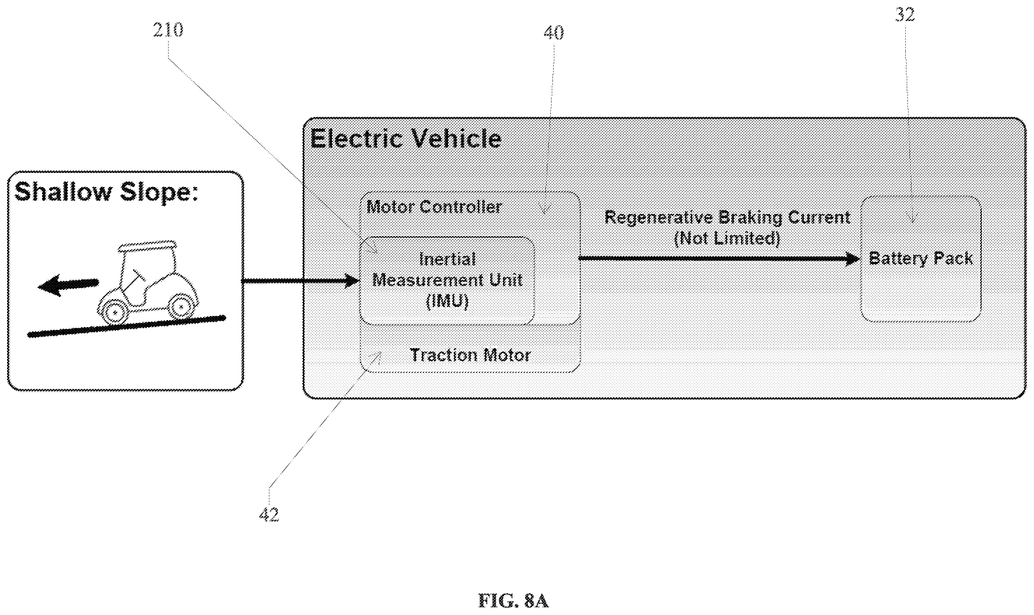

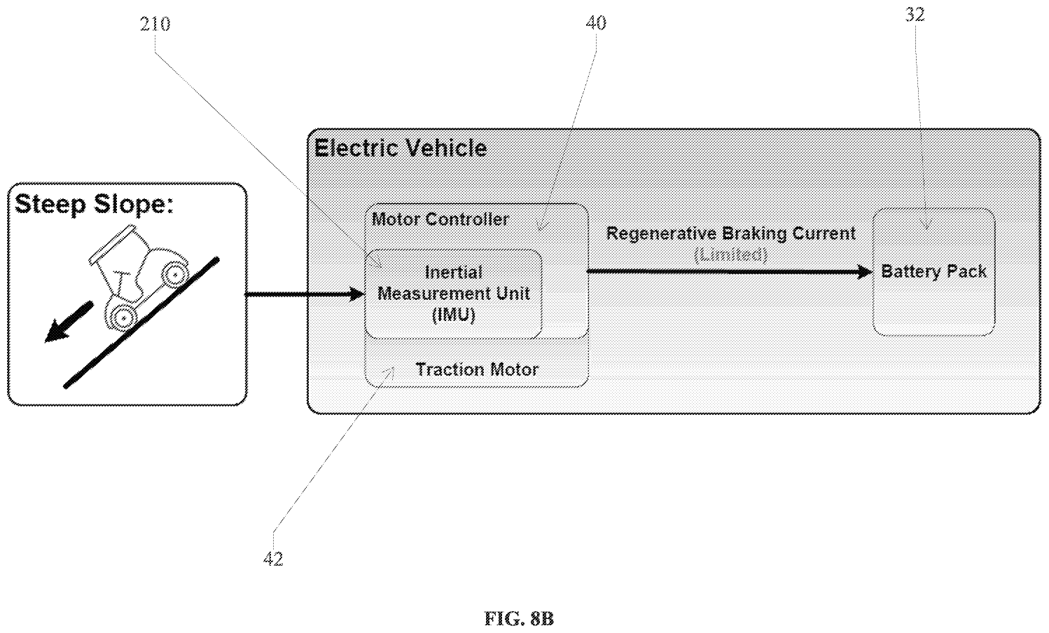

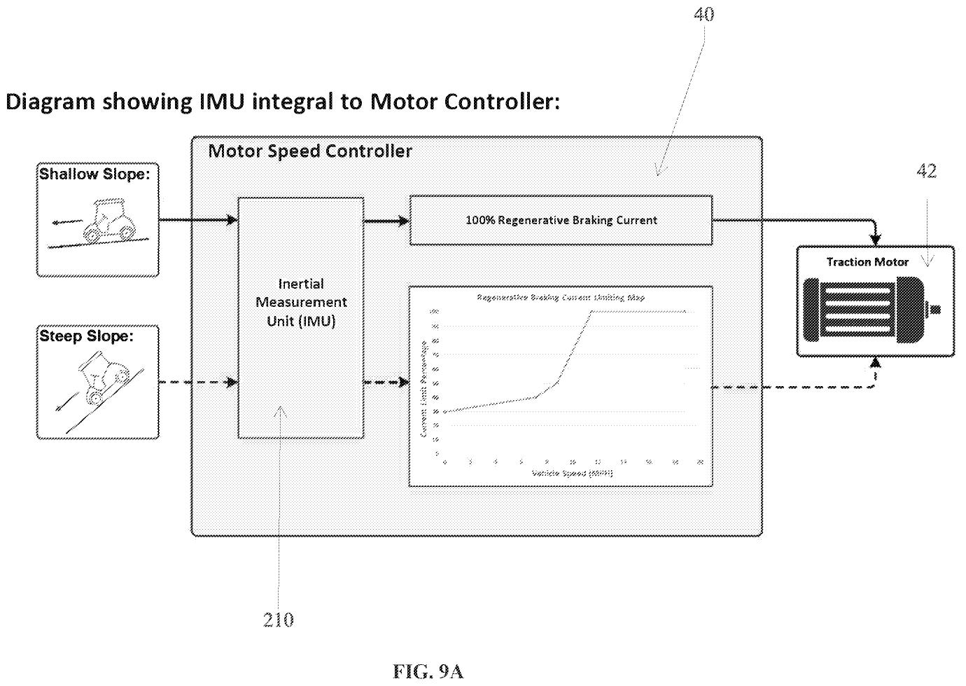

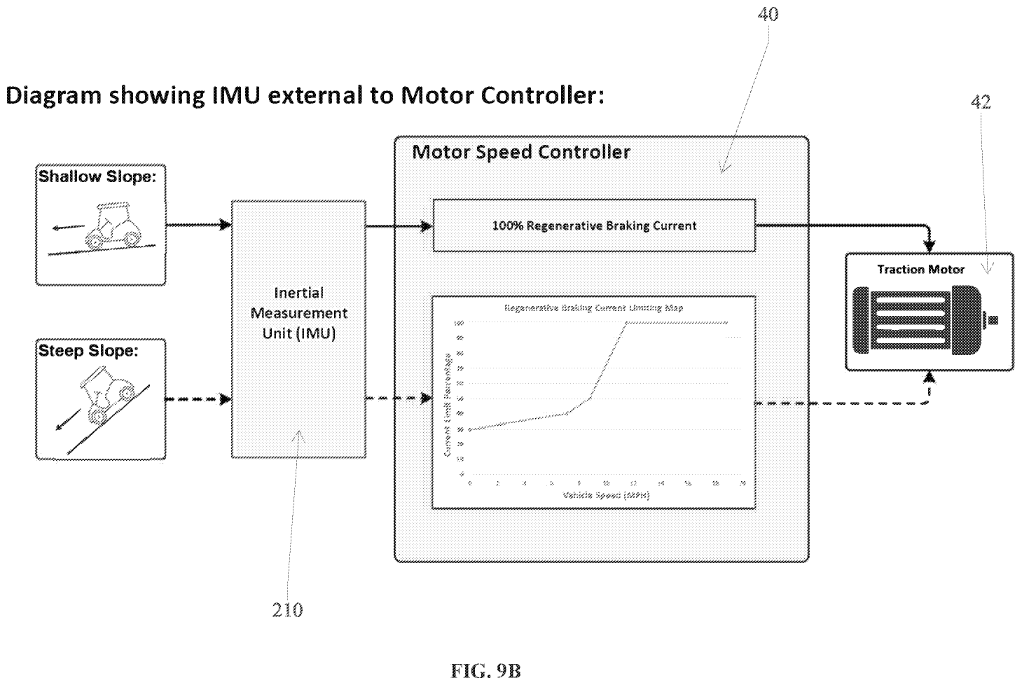

The additional circuitry 210 represents other circuitry of the control circuitry 200. Such circuitry may include sensor(s) 210, 320 (e.g., IMU shown in FIGS. 8-9), other interfaces, connectors, and so on. In some arrangements, where the utility vehicle is specialized equipment (e.g., a food and beverage vehicle, an ATV, etc.) for example, the additional circuitry 208 may represent other components such as an electronic thermostat, lighting control, and so on.

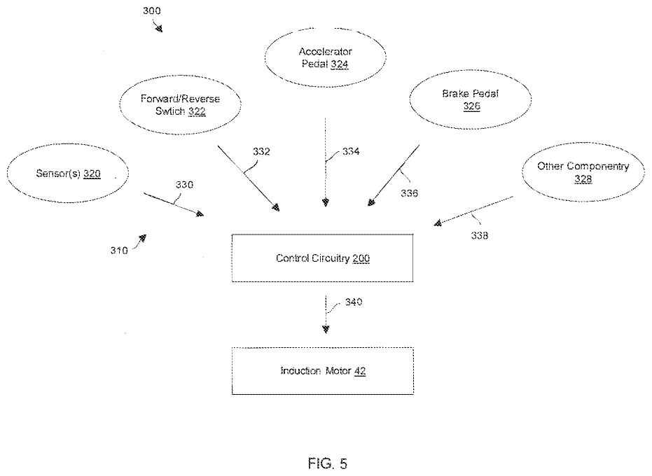

FIG. 5 diagrammatically shows various vehicle componentry 300 that provides input 310 (e.g., electric signals, bus messages, etc.) to the control circuitry 200, such as for regenerative braking control. The vehicle componentry 300 may include sensor(s) 320 (e.g., see sensors 210 in FIGS. 4 and 8-9), a forward/reverse switch 322, an accelerator pedal 324, a brake pedal 326, and other componentry 328.

The sensor(s) 320 may provide sensor information 330, such as angular positional data which may be indicative of a grade/slope on which the vehicle is operating, to the control circuitry 200. Such sensor information 330 may allow the control circuitry 200 to determine whether the vehicle is traveling downhill on a steep grade for example, on flat ground, on a shallow grade, and/or whether the vehicle is traveling on wet grass for example, and to control and adjust regenerating braking based thereon.

The forward/reverse switch 322 may provide a switch direction signal 332 to the control circuitry 200. The switch direction signal 332 identifies the current position of the forward/reverse switch 332 which is controlled by the vehicle operator (e.g., forward position, reverse position, neutral position, etc.).

The accelerator pedal 324 may provide an accelerator pedal signal 334 to the control circuitry 200. The accelerator pedal signal 334 identifies the current position of the accelerator pedal 324 which is controlled by the vehicle operator (e.g., a current angle of displacement, fully depressed, fully released, etc.).

The service brake pedal 326 may provide a brake pedal signal 336 to the control circuitry 200. The brake pedal signal 336 may identify the current position of the brake pedal 326 which is controlled by the vehicle operator (e.g., a current angle of displacement, fully depressed, fully released, etc.). A brake pedal, brake switch, and/or associated elements may be omitted in certain example embodiments.

The other componentry 328 may provide other signals 338 to the control circuitry 200. For example, the other signals 338 may indicate whether a tow switch of the utility vehicle 20 has been set to enabling vehicle towing, whether the utility vehicle 20 is currently connected to an external charger to charge the rechargeable battery 52, whether an operator has inserted a key into a keyed switch of the utility vehicle 20 and turned the keyed switch, whether a certain fault has occurred, and so on.

During operation and based on the input 310 from the vehicle componentry 300, the control circuitry 200 may determine how to operate the motor 42 and outputs appropriate motor control input 340 to the motor 42. The motor 42 may respond by rotating, providing regenerative braking, etc.

In accordance with certain embodiments, the utility vehicle 20 may perform regenerative braking in different regenerative braking modes. In an example regenerative braking mode (e.g., a non-limiting regenerative braking mode), the control circuitry 200 of the utility vehicle 20 may impose regenerative braking based on the current wheel speed and the commanded speed. For example, the current wheel speed may be sensed as motor speed (e.g., the motor spins with the wheels at a fixed ratio) and the commanded speed may be sensed through accelerator pedal position (e.g., percentage of accelerator pedal actuation commands the same percentage of the maximum programmed vehicle wheel speed limit). The control circuitry 200 may compare the current wheel speed with the commanded speed and adjust regenerative braking power (e.g., torque and/or current) to bring the current wheel speed to the commanded speed at a predetermined deceleration rate (e.g., to reduce the current wheel speed from 10 mph to a commanded 5 mph at the predetermined rate of −5 mph per second). In some embodiments, the control circuitry 200 may use a closed feedback loop to measure the current wheel speed to adjust the regenerative braking power to maintain the desired deceleration rate. In this mode, for example, the full percentage of the regenerative braking power limit may be available to the control circuitry 200 regardless of the current wheel speed of the utility vehicle 20 (e.g., see FIG. 8A). This mode may be used with the maximum limit discussed herein.

In some embodiments, in another regenerative braking mode hereinafter referred to as “a power-limiting regenerative braking mode”, the control circuitry 200 of the utility vehicle 20 operates similarly to the non-limiting regenerative braking mode, but limits the regenerative braking power available based on the data from the sensor(s) 210/320 such as angular positional data 330 which may be indicative of a grade/slope on which the vehicle is operating. Such sensor information 330 may allow the control circuitry 200 to determine whether the vehicle is traveling downhill on a steep grade for example, on flat ground, on a shallow grade, and/or whether the vehicle is traveling on wet grass for example, and to control and adjust regenerating braking based thereon. For example, see FIGS. 6, 8B, and 9A-9B. The power-limiting regenerative braking mode may be suited for when the vehicle operator partially or fully releases the accelerator pedal 324 of the utility vehicle 20 while the utility vehicle 20 is moving in the forward direction, such as downhill. In such a situation, the control circuitry 200 controls regenerative braking power based on a power limiting function. Here, the control circuitry 200 directs the motor 42 to provide regenerative braking where the regenerative braking power limit is based on the angular positional data of the utility vehicle 20 which may be determined via the sensor(s) 210, 320 (e.g., see the sensors 210 in FIGS. 8-9). In accordance with certain embodiments, the regenerative braking power is greatly limited when the vehicle is travelling downhill on steep grades, but is not so limited on flat ground and/or when the vehicle is on shallow grade(s) (e.g., see FIGS. 6 and 8-9).

For example, suppose that the vehicle operator wishes to drive the utility vehicle 20 in the forward direction by depressing the accelerator pedal 324. In this situation, the control circuitry 200 confirms that the forward/reverse switch 322 is in the forward position based on the switch direction signal 332. Additionally, the control circuitry 200 senses that the operator has depressed the accelerator pedal 324 based on the accelerator pedal signal 334 and that the operator has not depressed the brake pedal 326 based on the brake pedal signal 336. Furthermore, the control circuitry 200 analyzes the other signals 338 from the other componentry to verify that it is safe to drive the motor 42. Accordingly, the control circuitry 200 provides motor control input 340 to the motor 42 to operate the motor 42. For example, using electric power from the rechargeable battery 52, the control circuitry 200 may provide a three-phase AC current to the motor 42 to turn the rotor of the motor in the forward direction and thus rotate the drive wheel(s) 24 of the utility vehicle 20 in the forward direction to move the utility vehicle 20 forward. The control circuitry 200 controls current speed of the utility vehicle 20 by continuing to sense the input 310 from the vehicle componentry 300 and outputting the three-phase AC current at an appropriate frequency and amplitude, e.g., the motor control input 340.

Now, suppose that the vehicle operator partially or fully releases the accelerator pedal 324 while the utility vehicle 20 moves in the forward direction. In this situation, the control circuitry 200 confirms that the forward/reverse switch 322 is still in the forward position based on the switch direction signal 332. Additionally, the control circuitry 200 senses that the operator has at least partially released the accelerator pedal 324 based on the accelerator pedal signal 334 and that the operating has not depressed the brake pedal 326 based on the brake pedal signal 336. Furthermore, the control circuitry 200 analyzes the other signals 330, 338 from the other componentry to verify that it is safe to operate the motor 42 in a regenerative braking mode in which the motor 42 generates electrical energy from kinetic energy of the moving utility vehicle 20. To this end, the control circuitry 200 provides motor control input 340 to the motor to provide regenerative braking which slows the utility vehicle 20 and recharges the rechargeable battery 52. For example, the control circuitry 200 fashions the frequency and amplitude of the three-phase AC current based on power limiting data (e.g., see the configuration data 226 in FIG. 4) to provide an appropriate braking torque that reduces tire skidding, with the power limiting data being adjusted and based on the slope on which the vehicle is currently operating. For example, on steep downhill grades there may be more significant limiting, compared to on shallow downhill grades and/or flat ground, in order to reduce skidding/slipping. For example, at and below the power limit, the regenerative braking torque that the motor 42 provides to the drive wheels 24 of the utility vehicle 20 is to be less than the coefficient of friction between the drive wheels 24 and the drive surface (e.g., grass, dirt, or pavement). As a result, the drive wheels 24 are less prone to slipping and skidding thus improving safety of the vehicle 20.

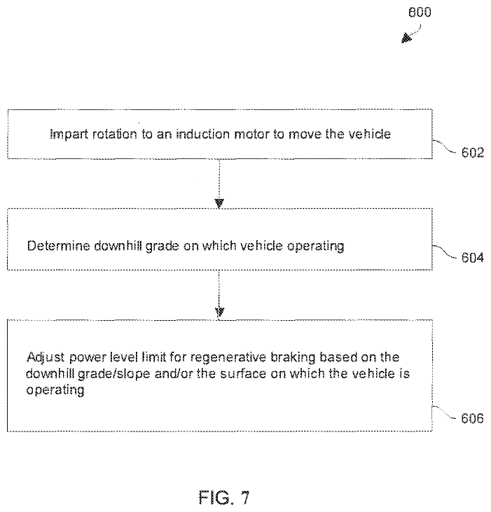

In accordance with certain example embodiments, the power-limiting regenerative braking mode (e.g., see FIGS. 7, 8B, and 9A-9B) is only active when the utility vehicle 20 is moving in the forward direction. Otherwise, the power-limiting regenerative braking mode may be inactive/de-activated. Such forward direction determination may be made from the input 310 (e.g., the motor sensor information 330, the switch direction signal 332, other input, combinations thereof, etc.).

Additionally, in accordance with certain example embodiments, the power-limiting regenerative braking mode (e.g., see FIGS. 7, 8B, and 9A-9B) is only active when the brake pedal signal 336 indicates that the service brake pedal 326 is not currently depressed. Otherwise, the power-limiting regenerative braking mode is inactive/de-activated. However, in other example embodiments, the power-limiting regenerative braking mode (e.g., see FIGS. 7, 8B, and 9A-9B) may be active when the brake pedal 326 is pressed. In some arrangements, the service brake pedal 326 provides a constant brake pedal signal 336 indicating the current status of the brake pedal 326. In other arrangements, the service brake pedal 326 provides, as the brake pedal signal 336, a service brake command whenever the brake pedal 326 is depressed and the absence of the service brake command indicates that the brake pedal 326 is not depressed.

FIG. 6 shows a graph of an example power limiting function (or curve) 400 that may be provided by the control circuitry 200 of the utility vehicle 20 (other example power limiting function graphs are shown in the graphs of FIGS. 9A-9B). In FIG. 6, the Y axis of the graph shows the percentage, by which, the regenerative braking power has been reduced; as an example 60 would mean that the regenerative braking power has been reduced by 60% leaving only 40% of the regenerative braking limit available for regenerative braking. The example power limiting function 400 in FIG. 6 is a plot of downhill slope/grade on which the vehicle is currently operating vs. power limit percentage. It is also noted that the x-axis of the graphs in FIGS. 9A-9B may be based on speed and/or angular orientation of the vehicle. It should be understood that the particular values (or coordinates) for the power limiting function 400 of FIG. 6 (and FIGS. 9A-9B) are by way of example only and that, in other arrangements, the values are different and may be based on a variety of factors. Such factors may include the maximum speed for the utility vehicle 20, the types of treads on the tires 24, tire diameter, motor size, drive ratio, the type of terrain and/or environment, the vehicle's weight, the vehicle's application, and so on. In some embodiments the power limiting map of a utility vehicle 20 can be modified when these factors change. For example, the operator could select various inputs based on the operating condition that day or for a particular activity (e.g., tire size change, surface condition change, fully loaded vehicle, or any other non-standard operation condition).

It should be further understood that the example power limiting function 400 is based on the downhill grade/slope upon which the vehicle is currently determined to be operating, which is based on measured/sensed data from sensor(s) 210/320 (e.g., see FIGS. 5 and 7-9). However, this function may also be based on other factors such as vehicle speed, whether the driving surface is wet or dry, and so forth.

In certain example embodiments, the regenerative braking power becomes more limited as the grade of a downhill slope increases. As shown in the example of FIG. 6, the control circuitry 200 provides no limits on regenerative braking (other than possible the maximum limit discussed herein) at a 0 degree grade (flat ground) and on downhill grades from 0-2 degrees. In some embodiments, if the control circuitry 200 imposes regenerative braking while the utility vehicle speed is moving on such grades, the control circuitry 200 may allow the rechargeable battery 52 to absorb up to 100% of the maximum available power generated by the motor 42 and thus provide maximum braking torque.

However, as further shown in FIG. 6, the control circuitry 200 decreases (upward slope in FIG. 6) the amount of regenerative braking power available once the utility vehicle is determined to be traveling downhill on a grade/slope of at least 2 degrees. For example, on a 3 degree downhill grade, the control circuitry 200 imposes regenerative braking limit at 80% of the maximum available power generated by the motor 42 (i.e., 20% limit on the curve in FIG. 6). Additionally, on a 10 degree downhill grade, the control circuitry 200 imposes regenerative braking limit at 50% of the maximum available power generated by the motor 42. Thus, FIG. 6 shows that the limiting of regenerative braking increases as the downhill grade becomes steeper.

Due to such increased limiting of regenerative braking power on large downhill grades/slopes as shown in FIG. 6 (and FIGS. 8-9), regenerative braking torque applied to the drive wheels 24 is weaker on such large downhill grades/slopes. Accordingly, the drive wheels 24 are allowed to rotate more freely and the regenerative braking torque remains less than the coefficient of friction between the drive wheels 24 and the drive surface. As a result, the drive wheels 24 are less prone to slipping and skidding thus improving vehicle safety.

Along these lines, a power limiting map may be preprogrammed, e.g., stored as a file or lookup table in memory (e.g., see the configuration data 226 in FIG. 4). The map entries may map slope/grade and/or motor rotation rates to respective power level settings, as discussed herein (e.g., see FIGS. 6 and 9). For example, each map entry may include a speed (or rotation rate) field to store speed data, a slope/grade field, and a percentage of regenerative power field to store power level data, and possibly other fields to store other information such as motor operating parameters, etc. In some embodiments, the control circuitry 200 of the utility vehicle 20 may be able to perform a variety of different operations, or operate in a variety of different environments/settings. Accordingly, the control circuitry 200 may be preloaded with multiple power limiting maps that are selectable by a user. In some embodiments, a power limiting map may be derived during utility vehicle use. For example, the control circuitry may derive the power limiting map dynamically, on the fly, in real time, over the course of use via artificial intelligence, etc., such as based on what grade(s) and/or speed(s) the wheels begin to slip/skid, and so forth. Additionally, the control circuitry 200 may use a set of rules, policies, functions, and/or algorithms in addition to or in place of the power limiting map to provide the power limiting function. Other implementations are suitable for use as well.

FIG. 7 is a flowchart of a procedure 600 which is performed by a vehicle to reduce skidding of the vehicle in accordance with some example embodiments. In particular, control circuitry 200 of the vehicle performs the procedure 600 to control regenerative braking.

At 602, the control circuitry imparts rotation to an induction motor of the vehicle to move the vehicle. Along these lines, the control circuitry may sense that the forward/reverse switch is set to a forward position, sense depression of the accelerator pedal, and in response drive the motor to move the vehicle in the forward direction.

At 604, during vehicle operation, the control circuitry determines the grade/slope (e.g., downhill grade/slope) on which the vehicle 20 is traveling, based on data from the sensor(s) 210, such as based on angular positional data regarding the vehicle.

At 606, while control circuitry 200 adjusts the power level limit for regenerative braking based on the determined downhill grade/slope. For example, see FIGS. 6, 8B, and 9. Limiting is increased as downhill grades/slopes becomes larger. Such operation reduces the possibility of the tires slipping/skidding. Accordingly, the operator is able to maintain robust and reliable control of the vehicle. Improved techniques are directed to controlling regenerative braking by a motor 42 of a vehicle 20 to reduce skidding of the vehicle 20. Such techniques may reduce the power available from regenerative braking on steep slopes. Such reduction of regenerative braking power lowers the amount of braking torque imposed by the motor 42 on the drive wheels 24 of the vehicle 20. Accordingly, the drive wheels 24 are less prone to slipping/skidding on the drive surface thus improving safety of the vehicle 20.

FIGS. 8(A)-(B) are diagrams of controlling regenerative braking in an electric vehicle according to certain example embodiments. FIG. 8A shows the non-limited mode (with the possible exception of the maximum limit discussed herein) for use on flat ground, uphill use, and/or a shallow downhill slope, and FIG. 8B shows a limited mode where regenerative braking power/torque is limited due to determination that the vehicle is operating on a steep slope. The at least one sensor 210 may be or include an inertial measurement unit (IMU) comprising at least one sensor for measuring at least angular orientation of the vehicle. The IMU may, for example, include at least one sensor for tracking acceleration, angular velocity, and/or angular orientation of the vehicle, and may include a gyroscope(s) and/or an accelerometer(s) for example. For example, the IMU may include three accelerometers, three gyroscopes, and depending on the heading requirement, one or more magnetometers. Such as one per axis for each of the three vehicle axes: roll, pitch, and yaw. The IMU may be (or may not be) integrated with a motor controller of the vehicle, where the motor controller is for controlling speed of the motor, in various example embodiments.

The IMU 210 may output measured signals to the control circuitry 200 so that the control circuitry can determine the grade/slope on which the vehicle is operating for example, or the IMU 210 may be considered to be part of the control circuitry and may itself determine such a grade/slope. By using the angular data from the IMU, a controller comprising processing circuitry (e.g., a motor controller 40) may be configured to reduce regenerative current limits (further limit regenerating power available) to prevent or reduce a likelihood of skidding when necessary (e.g., while descending a steep hill) as shown in FIG. 8B, and allow full and/or a higher amount of regenerative current in less skid-likely scenarios such as on shallow grades and/or flat ground such as shown in FIG. 8A. For example and without limitation, a controller (e.g., of or including a processor, and/or circuitry 200) may be configured to limit regenerative braking on steep grades (e.g., grades of at least 5 degrees relative to the horizontal) as shown in FIG. 8B, and not to limit regenerative braking and for instance allow full or a higher amount of regenerative current on low grades (e.g., grades less than 5 degrees relative to the horizontal), flat ground, and/or uphill as shown in FIG. 8A. Thus, for example and without limitation, a controller (e.g., of or including a processor, and/or circuitry 200) may be configured to limit regenerative braking on steep grades (e.g., grades of at least 5 degrees relative to the horizontal) as shown in FIG. 8B so that the vehicle 20 does not slow down as quickly, and for instance allow full or a higher amount of regenerative current so that the vehicle 20 can slow down more quickly on low grades (e.g., grades less than 5 degrees relative to the horizontal), flat ground, and/or uphill as shown in FIG. 8A, for purposes of safety discussed herein. FIGS. 8A-8B also illustrate that the regenerative braking recharges the battery 32.

While FIG. 8 shows the IMU 210 as part of the motor controller 40, that is just an example. The IMU may also or instead be part of the control circuitry 200, part of the battery management system, or may be located as a standalone unit in various example embodiments.

Such techniques (e.g., see FIGS. 6-9) may reduce the power available from regenerative braking on steep hills for example. Such reduction of regenerative braking power lowers the amount of braking torque imposed by the motor 42 on the drive wheels of the vehicle 20. Accordingly, vehicle wheels are less prone to slipping and/or skidding on the steep and/or slippery drive surfaces for example, thus improving safety of the vehicle.

FIGS. 9(A)-(B) are diagrams of a system for controlling regenerative braking in an electric vehicle according to certain example embodiments. FIG. 9A shows an embodiment where the IMU 210 is part of the motor speed controller 40, whereas FIG. 9B shows an embodiment where the IMU 210 is separate from the motor speed controller 40. FIGS. 9A-9B illustrate that the non-limited mode (with the possible exception of the maximum limit discussed herein) is used when the vehicle 20 is on the shallow slope, such that 100% of the allowable regenerative braking current can be utilized; and show that when the control circuitry 200 determines that the vehicle 20 is on the steep slope a limited mode is utilized where regenerative braking power/torque is limited. The non-limited mode is shown in the upper part of FIGS. 9A-9B, whereas the limited mode is shown in the lower part of FIGS. 9A-9B. It is noted that the x-axis of the graphs in FIGS. 9A-9B may be based on speed and/or angular orientation of the vehicle, so that the regenerative braking is adjusted based on the slope/grade of the operating surface and/or vehicle speed.

In accordance with certain embodiments, the utility vehicle may employ an AC electrical architecture of an AC-powered electric vehicle. For example, the utility vehicle may operate the AC drive system to provide regenerative braking in response to a throttle command from the accelerator pedal and/or a brake command from the service brake pedal.

In the reverse direction, the power limiting need not be active in certain example embodiments. This is to ensure full regenerative braking capability for anti-rollback and position holding functions. Additionally, the power limiting need not be active when there is a braking command to the AC drive controller from a service brake pedal input from the vehicle operator, in certain example embodiments. This may help full braking power to be available for braking as commanded by the vehicle operator. In various example embodiments, there are other conditions where regenerative limiting may be turned off, such as responses to certain faults/conditions (e.g., key turned off while driving, loss of communication between BMS and controller, BMS declaring a shut down, and/or the like).

In accordance with certain embodiments, particular improvements disclosed herein are employed on any specialized vehicle that has an AC or DC powered drive system. Such improvements are not specific to battery type or AC or DC motor technology type. Such improvements are suitable for us in any industry that employs a vehicle with an AC or DC powered drive system.

It should be appreciated that the improvements disclosed herein were described in the context of motors by way of example. Other types of synchronous and asynchronous motor technologies are suitable for use as well such as permanent magnet AC, brushless DC, switched reluctance, other synchronous and/or asynchronous systems, and so on.

In an example embodiment, there is provided an electric vehicle comprising: a vehicle body; at least one sensor configured to data of the vehicle; a rechargeable battery supported by the vehicle body; a motor configured to drive at least one wheel of the vehicle; and control circuitry coupled with the rechargeable battery, the at least one sensor, and the motor; wherein the control circuitry is configured to control regenerative braking of the vehicle at least by adjusting a limit of regenerative braking power available to the vehicle based on positional data based on the data from the at least one sensor. The positional data may be the same data from the at least one sensor, or may be modified and/or processed based on the data from the at least one sensor.

In the electric vehicle of the immediately preceding paragraph, the positional data may comprise angular positional data indicative of a grade/slope on which the vehicle is operating, and the at least one sensor may be configured so that the data from the at least one sensor comprises at least one of: acceleration, angular speed, and/or angular position.

In the electric vehicle of any of the preceding two paragraphs, the regenerative braking may also be for recharging the battery.

In the electric vehicle of any of the preceding three paragraphs, the control circuitry may be configured for: imparting rotation to the motor to move the vehicle based on a forward/reverse switch of the vehicle being in a forward position, a position of an accelerator pedal of the vehicle being pressed.

In the electric vehicle of any of the preceding four paragraphs, the control circuitry may be configured for applying a power level limit for regenerative braking to the motor based on the angular positional data, and causing the motor to provide braking torque that slows the vehicle based on the power level limit. The applying the power level limit for regenerative braking to the motor based on the angular positional data may comprise: determining that the vehicle is moving in a forward direction, based on the vehicle moving in the forward direction and on the angular positional data being indicative of a grade/slope on which the vehicle is operating, causing the motor to provide a braking torque that slows the vehicle based on the grade/slope of ground on which the vehicle is operating.

In the electric vehicle of any of the preceding five paragraphs, the control circuitry may be configured to provide additional limiting of regenerative braking power available to the vehicle as a grade/slope of a downhill slope on which the vehicle is operating increases, so as to (a) allow the vehicle to have unrestricted or less restricted regenerative braking for more quickly slowing the vehicle on flat ground and/or small grades/slopes, and (b) limit, and/or more significantly limit, the vehicle's deceleration when the vehicle is traveling downhill on a steep grade to reduce chances of sliding/skidding, so that the regenerative braking power available to the vehicle is more limited when operating downhill on steep grades/slopes compared to on flat ground and/or small grade/slopes.

In the electric vehicle of any of the preceding six paragraphs, the control circuitry may be further configured to control regenerative braking of the vehicle by adjusting the limit of regenerative braking power available to the vehicle based on a speed of the vehicle and/or wheel(s) thereof.

In the electric vehicle of any of the preceding seven paragraphs, the vehicle may be a golf cart or any other suitable vehicle with a rechargeable battery.

In the electric vehicle of any of the preceding eight paragraphs, the battery may comprise lithium.

In the electric vehicle of any of the preceding nine paragraphs, the at least one sensor may comprise an inertial measurement unit (IMU) comprising at least one sensor for measuring at least angular orientation of the vehicle. The IMU may, for example, include at least one sensor for tracking acceleration, angular velocity, and/or angular orientation of the vehicle, and may include a gyroscope(s) and/or an accelerometer(s) for example. For example, the IMU may include three accelerometers, three gyroscopes, and depending on the heading requirement, one or more magnetometers. Such as one per axis for each of the three vehicle axes: roll, pitch, and yaw. The IMU may be (or may not be) integrated with a motor controller of the vehicle, where the motor controller is for controlling speed of the motor.

Each embodiment herein may be used in combination with any other embodiment(s) described herein. While example embodiments have been described in connection with what is presently considered to be the most practical and preferred embodiment(s), it is to be understood that the inventions are not to be limited to the disclosed embodiments, but on the contrary, are intended to cover various modifications and equivalent arrangements included within the spirit and scope of the appended claims.

1. An electric vehicle comprising:
a vehicle body;
at least one sensor configured to data of the vehicle;
a rechargeable battery supported by the vehicle body;
a motor configured to drive at least one wheel of the vehicle; and
control circuitry coupled with the rechargeable battery, the at least one sensor, and the motor;
wherein the control circuitry is configured to control regenerative braking of the vehicle at least by adjusting a limit of regenerative braking power available to the vehicle based on positional data based on the data from the at least one sensor.

2. The electric vehicle of claim 1, wherein the positional data comprises angular positional data indicative of a grade/slope on which the vehicle is operating, and wherein the at least one sensor is configured so that the data from the at least one sensor comprises at least one of: acceleration, angular speed, and/or angular position.

3. The electric vehicle of claim 1, wherein the regenerative braking is for recharging the battery.

4. The electric vehicle of claim 1, wherein the control circuitry is configured for: imparting rotation to the motor to move the vehicle based on a forward/reverse switch of the vehicle being in a forward position, a position of an accelerator pedal of the vehicle being pressed.

5. The electric vehicle of claim 1, wherein the control circuitry is configured for applying a power level limit for regenerative braking to the motor based on the positional data, and causing the motor to provide braking torque that slows the vehicle based on the power level limit.

6. The electric vehicle of claim 5, wherein the applying the power level limit for regenerative braking to the motor based on the positional data comprises:
determining that the vehicle is moving in a forward direction,
based on the vehicle moving in the forward direction and on the positional data from the at least one sensor being indicative of a grade/slope on which the vehicle is operating, causing the motor to provide a braking torque that slows the vehicle based on the grade/slope of ground on which the vehicle is operating.

7. The electric vehicle of claim 1, wherein the control circuitry is configured to provide additional limiting of regenerative braking power available to the vehicle as a grade/slope of a downhill slope on which the vehicle is operating increases, so as to (a) allow the vehicle to have unrestricted or less restricted regenerative braking for more quickly slowing the vehicle on flat ground and/or small grades/slopes, and (b) limit, and/or more significantly limit, the vehicle's deceleration when the vehicle is traveling downhill on a steep grade to reduce chances of sliding/skidding, so that the regenerative braking power available to the vehicle is more limited when operating downhill on steep grades/slopes compared to on flat ground and/or small grade/slopes.

8. The electric vehicle of claim 1, wherein the control circuitry is further configured to control regenerative braking of the vehicle by adjusting the limit of regenerative braking power available to the vehicle based on a speed of the vehicle and/or wheel(s) thereof.

9. The electric vehicle of claim 1, wherein the vehicle is a golf car.

10. The electric vehicle of claim 1, wherein the battery comprises lithium.

11. The electric vehicle of claim 1, wherein the at least one sensor comprises an inertial measurement unit (IMU) comprising at least one sensor for measuring at least angular orientation of the vehicle.

12. The electric vehicle of claim 11, wherein the IMU is integrated with a motor controller of the vehicle, and wherein the motor controller is for controlling speed of the motor.

13. The electric vehicle of claim 11, wherein the IMU comprises at least one gyroscope and at least one accelerometer.

14. A method of performing regenerative braking in a vehicle, the method comprising:
at least one sensor of the vehicle detecting data of the vehicle; and
controlling regenerative braking of the vehicle, which recharges a battery of the vehicle, at least by adjusting a limit of regenerative braking power available to the vehicle based on angular positional data based on the data from the at least one sensor.

15. The method of claim 14, wherein the angular positional data is indicative of a grade/slope on which the vehicle is operating, and wherein the data from the at least one sensor comprises at least one of: acceleration, angular speed, and/or angular position.

16. The method of claim 14, further comprising applying a power level limit for regenerative braking to a motor of the vehicle based on the angular positional data, and causing the motor to provide braking torque that slows the vehicle based on the power level limit.

17. The method of claim 14, wherein the adjusting a limit of regenerative braking power available to the vehicle based on the angular positional data comprises:
providing additional limiting of regenerative braking power available to the vehicle as a grade/slope of a downhill slope on which the vehicle is operating increases, so as to (a) allow the vehicle to have unrestricted or less restricted regenerative braking for more quickly slowing the vehicle on flat ground and/or small grades/slopes, and (b) limit, and/or more significantly limit, the vehicle's deceleration when the vehicle is traveling downhill on a steep grade to reduce chances of sliding/skidding, so that the regenerative braking power available to the vehicle is more limited when operating downhill on steep grades/slopes compared to on flat ground and/or small grade/slopes.

18. The method of claim 14, further comprising adjusting the limit of regenerative braking power available to the vehicle based on a speed of the vehicle.

19. An electric vehicle comprising:
a rechargeable battery;
a motor configured to drive at least one wheel of the vehicle; and
control circuitry coupled with the rechargeable battery and the motor;
wherein the control circuitry is configured to control regenerative braking of the vehicle to reduce a chance of vehicle skidding at least by adjusting regenerative braking for the vehicle based on at least one of: a slope/grade on which the vehicle is operating, or a degree of wetness of a surface on which the vehicle is operating.

20. The electric vehicle of claim 19, wherein the control circuitry is configured to adjust the regenerative braking for the vehicle based on the slope/grade on which the vehicle is operating.
